(19) United States
(12) Patent Application Publication
(10) Pub. No.: US 2019/0246671 A1
(43) Pub. Date: Aug. 15, 2019

(54) COMPOSITION FOR IMPARTING/ENHANCING CHEESE FLAVOR, METHOD FOR PRODUCING COMPOSITION FOR IMPARTING/ENHANCING CHEESE FLAVOR, METHOD FOR IMPARTING CHEESE FLAVOR TO FOODS OR ENHANCING CHEESE FLAVOR OF FOODS, AND METHOD FOR PRODUCING FOODS WITH IMPARTED/ENHANCED CHEESE FLAVOR

(71) Applicant: J-OIL MILLS, Inc., Tokyo (JP)

(72) Inventors: Mika NISHIWAKI, Tokyo (JP); Jun IMAGI, Tokyo (JP)

(21) Appl. No.: 16/324,800

(22) PCT Filed: Aug. 10, 2017
(86) PCT No.: PCT/JP2017/029026

§ 371 Date: Feb. 11, 2019

(30) Foreign Application Priority Data
Aug. 22, 2016 (JP) 2016-161740

(51) Int. Cl. A23L 27/20; A23C 19/09

(52) U.S. Cl. CPC A23L 27/206; A23V 2002/00; A23C 19/0925

(57) ABSTRACT

A composition for imparting/enhancing cheese flavour is provided which is capable of imparting cheese flavour to foods, and enhancing the cheese flavour of foods. Furthermore, provided are: a method for producing the composition for imparting/enhancing cheese flavour; a method for imparting cheese flavour to foods or enhancing the cheese flavour of foods; and a method for producing foods with imparted/enhanced cheese flavour. The composition for imparting/enhancing cheese flavour has, as an active ingredient, an oxidized oil or fat which has a peroxide value of 15 to 280, and which includes at least 10 mass % but not more than 100 mass % of milk fat. Furthermore, in the method for imparting cheese flavour to foods or enhancing the cheese flavour of foods, an oxidized oil or fat, which has a peroxide value of 15 to 280, and which includes at least 10 mass % but not more than 100 mass % of milk fat, is added to a food. Moreover, in the method for producing foods with imparted/enhanced cheese flavour, the composition for imparting/enhancing cheese flavour is added to a food. The present invention is particularly and preferably applicable to foods including cheese.

### TECHNICAL FIELD

The present invention. relates to a composition for imparting/enhancing a cheese flavor and a method for producing a composition for imparting/enhancing a cheese flavor, the composition and method being applied to the imparting and/or enhancement of a cheese flavor to/of foods, a method for imparting a cheese flavor to foods or enhancing the cheese flavor of foods, and a method for producing foods with an imparted/enhanced cheese flavor.

### BACKGROUND ART

There are known flavor oils in which an edible oil or fat. is treated by an essence or an ingredient, whereby a flavor derived from the essence or ingredient is imparted. For various ingredients, such as: green onion, garlic, chili pepper, basil, and other such vegetables; shrimp, dried sardines, dried bonito, and other such marine products; soy sauce and other such seasonings; etc., it is possible to easily perform cooking, processing, and other such procedures on foods in which a characteristic flavor derived from the ingredient is enhanced. Therefore, these flavor oils are popular in industrial settings, as shall be apparent, and also with household consumers.

In relation to the imparting of an. essence or flavor to a food, attempts for imparting a butter flavor using milk fat have been carried out. For example, patent document 1 (Japanese Laid-Open Patent Application No. 64-39962) discloses a method for producing a food to which a buttery essence has been. imparted, the method involving adding butter fat that contains a prescribed amount of a prescribed compound. In addition, patent document 2 (Japanese Laid-Open Patent Application No. 09-94062) discloses a method for producing a butter essence in which, after milk fat has been hydrolyzed by enzymes, the milk fat is irradiated with ultraviolet rays and oxidized such that the peroxide value (POV) is within the range of 1.5 to 9.0.

### [RELATED ART DOCUMENTS]

### Patent Documents

[Patent Document 1] Japanese Laid-Open Patent Application No. 64-39962

[Patent Document 2] Japanese Laid-Open Patent. Application No. 09-94062

### DISCLOSURE OF THE INVENTION

### Problems to Be Solved by the Invention

However, no cheese-flavored flavor oil has been obtained, even when a flavor oil having cheese as an ingredient is prepared in accordance with a typical method for preparing a flavor oil, In addition, although the features disclosed. in patent documents 1 and 2 achieve a butter flavor, these features lack an effect for imparting a cheese flavor to foods or enhancing a cheese flavor of foods.

Accordingly, it is an object of the present invention to provide a composition for imparting and/or enhancing a cheese flavor with which it is possible to impart a cheese flavor to foods and/or enhance the cheese flavor of foods. Additional objects of the present invention include providing a method for producing a composition for imparting and/or enhancing a cheese flavor, providing a method for imparting a cheese flavor to foods or enhancing the cheese flavor of foods, and providing a method for producing foods with an imparted/enhanced. cheese flavor.

### Means to Solve the Problems

As a result of thoroughgoing investigations for the purpose of attaining the objects described above, the inventors discovered that an oxidized oil or fat including milk fat and having specified properties yields an exceptional effect for imparting a cheese flavor to foods and enhancing the cheese flavor of foods, and thereby perfected the present invention.

Specifically, according to a first aspect of the present invention, there is provided a composition for imparting and/or enhancing a cheese flavor, the composition comprising, as an active ingredient, an oxidized oil or fat that has a peroxide value of 15 to 280 and contains 10 to 100% by mass of milk fat.

The composition for imparting and/or enhancing a cheese flavor of the present invention preferably further comprises an edible oil or fat.

The composition for imparting and/or enhancing a cheese flavor of the present invention preferably contains 0.001 to 10% by mass of the oxidized oil or fat.

According to a second aspect of the present invention,

there is provided a method for producing a composition for imparting and/or enhancing a cheese flavor,

the method comprising a step for performing heating while supplying oxygen to a raw-ingredient oil or fat that contains 10 to 100% by mass of milk fat, and obtaining an oxidized oil or fat that has a peroxide value of 15 to 280.

The raw-ingredient oil or fat in the method for producing a composition for imparting and/or enhancing a cheese flavor of the present invention preferably contains 60 to 100% by mass of milk fat.

The heating in the method for producing a composition for imparting and/or enhancing a cheese flavor of the present invention. preferably is carried out at 65 to 150° C. for 1 to 72 hours.

The supply of oxygen in the method for producing a composition for imparting and/or enhancing a cheese flavor of the present invention. preferably is performed at a rate of 0.001 to 2 L/min per kilogram of the raw-ingredient oil or fat.

The milk fat in the method for producing a composition for imparting and/or enhancing a cheese flavor of the present invention preferably is anhydrous milk fat.

The method for producing a composition for imparting and/or enhancing a cheese flavor of the present invention preferably comprises a step for adding the oxidized oil or fat to an edible oil or fat.

The method for producing a composition for imparting and/or enhancing a cheese flavor of the present invention preferably is configured such that the composition contains 0.001 to 10% by mass of the oxidized oil or fat.

The food in the method for producing a composition for imparting and/or enhancing a cheese flavor of the present invention preferably contains a cheese.

According to a third aspect of the present invention, there is provided a method for imparting a cheese flavor to foods or enhancing the cheese flavor of foods, the method being characterized in that an oxidized oil or fat having a peroxide value of 15 to 280 and containing 10 to 100% by mass of milk fat is added to a food.

The oxidized oil or fat in the method. for imparting a cheese flavor to foods or enhancing the cheese flavor of foods of the present invention preferably is added to the food as a composition further containing an edible oil or fat.

The food in the method for imparting a cheese flavor to foods or enhancing the cheese flavor of foods of the present invention preferably contains a cheese.

The amount of the oxidized oil or fat added to the food in the method for imparting a cheese flavor to foods or enhancing the cheese flavor of foods of the present invention preferably is 0.00005 to 3% by mass in terms of the oxidized oil or fat content of the food.

According to a fourth aspect of the present invention, there is provided a method for producing foods with an imparted/enhanced cheese flavor, the method comprising adding the abovementioned composition for imparting and/or enhancing a cheese flavor to a food.

The food in the method for producing foods with an imparted/enhanced. cheese flavor of the present. invention preferably contains a cheese.

### Advantageous Effects of the Invention

According to the present invention, through use of an oxidized oil or fat including milk fat and having specified properties, there is achieved an effect for imparting and/or enhancing a cheese flavor to/of foods to which the oxidized oil or fat has been added.

### BEST MODE FOR CARRYING OUT THE INVENTION

The composition for imparting and/or enhancing a cheese flavor according to the present invention has, as an active ingredient, an oxidized. oil or fat containing milk fat. “Milk fat” refers to a substance that is obtained from raw milk, cow milk, certified milk, etc., and has an oil or fat content of 95 to 100% by mass. Examples include anhydrous milk fat, and clarified butter. Anhydrous milk fat refers to a substance in which substantially all components other than. milk fat have been removed from cow milk, etc., and may also be expressed as AMF, butter oil, etc. Clarified butter is a substance in which the oil or fat component of butter has been. fractionated. The milk fat an the present invention preferably is anhydrous milk fat or clarified butter, and more preferably is anhydrous milk fat. In addition, the oil or fat content of the milk fat preferably is 98 to 100% by mass, and more preferably is 99 to 100% by mass.

The oxidized oil or fat used in the present invention has a milk fat content of 10 to 100% by mass. This milk fat content preferably .is 15 to 100% by mass, more preferably is 20 to 100% by mass, even more preferably is 40 to 100% by mass, still more preferably is 50 to 100% by mass, particularly preferably is 65 to 100% by mass, more particularly preferably is 95 to 100% by mass, and most preferably is 100% by mass (i.e., milk fat alone).

The oxidized oil or fat may include an edible oil or fat other than milk fat. There is no particular limitation as to the edible oil or fat other than milk fat. One or more from among medium-chain fatty acid triglycerides, soybean oil, canola oil, corn oil, palm oil, and fractionated palm oil is preferred; one or more from among medium-chain fatty acid triglycerides, soybean oil, and canola oil is more preferred; and canola oil is even. more preferred. The oxidized oil or fat. may include an auxiliary agent, etc., that can be added to normal oils or fats, provided that the auxiliary agent does not inhibt the effect of the present invention.

The oxidized oil or fat used in the present invention has a peroxide value (also referred to as “POV” below) of 15 to 280. The peroxide value (POV) preferably is 25 to 265, more preferably is 30 to 265, even more preferably is 40 to 250, still more preferably is 52 to 250, and particularly preferably is 70 to 250. The peroxide value (POV) can be measured in conformance with, e.g., the method listed. in the Japan Oil Chemists' Society's “Standard. methods for the analysis of fats, oils and related materials: 2.5.2 Peroxide value,” etc.

The oxidized oil or fat used in the present invention can be prepared by, e.g., oxidizing a prescribed raw-ingredient oil or fat as described below. However, the description given below is in no way intended to limit the scope of the present invention particularly to oxidized. oils or fats obtained using this method. Specifically, any oxidized oil or fat satisfying the properties described above may be suitably used in the present. invention.

The raw-ingredient oil or fat for preparing the oxidized oil or fat has a milk fat content of 10 to 100% by Mass. This milk fat content preferably is 15 to 100% by mass, more preferably is 20 to 100% by mass, even more preferably is 40 to 100% by mass, still more preferably is 50 to 100% by mass, particularly preferably is 65 to 100% by mass, more particularly preferably is 95 to 100% by mass, and most preferably is 100% by mass (i.e., milk fat alone).

In addition, the raw-ingredient oil or fat may include an edible oil or fat. other than. milk fat. There is no particular limitation as to the edible oil or fat other than milk fat. One or more from among medium-chain fatty acid triglycerides, soybean. oil, canola oil, corn oil, palm oil, and fractionated palm oil is preferred; one or more from among medium-chain fatty acid triglycerides, soybean oil, and canola oil is more preferred; and canola oil is even more preferred. The water content. of the raw-ingredient oil or fat is, e.g., less than 1% by mass.

There is no particular limitation as to the method for oxidation; it is preferable to supply oxygen. to the raw-ingredient oil or fat to perform oxidation. It does not matter if the oxygen supply source is oxygen alone; the supply source may include oxygen from air, etc., and preferably is air. The oxygen supply quantity preferably is 0.001 to 2 L/min per kilogram of the raw-ingredient oil or fat, more preferably is 0.005 to 2 L/min, and even. more preferably is 0.02 to 2 L/min. In the case of air, for example, the supply quantity preferably is 0.005 to 10 L/min per kilogram of the raw-ingredient oil or fat, more preferably is 0.025 to 10 L/min, even more preferably is 0.1 to 10 L/min, and still more preferably is 0.3 to 5 L/min. It is preferable to stir the raw-ingredient oil or fat when performing oxidation. The temperature for performing oxidation preferably is 65 to 150° C., more preferably is 70 to 140° C., even more preferably is 75 to 140° C., and still more preferably is 90 to 140° C. There is no particular limitation as to the length of time for performing oxidation; 1 to 72 hours is preferred, 3 to 72 hours is more preferred, and 5 to 72 hours even more preferred.

The composition for imparting and/or enhancing a cheese flavor according to the present invention has the oxidized oil or fat described above as an active component for imparting and/or enhancing a cheese flavor to/of foods. The oxidized oii or fat may, for example, be used so as to be added to foods without further modification, or may be used so as to be added to foods in the form of a composition combined with a prescribed edible oil or fat. However, the oxdized oil or fat is not ljmited to these forms; the present invention may satisfactorily be configured such that an oxidized oil or fat satisfying the properties described above is used in an amount effective for the imparting and/or enhancement of a cheese flavor to/of foods.

An edible substance can be appropriately used as the edible oil or fat to be combined with the oxidized oil or fat.

Examples of this edible substance include: soybean oil, canola oil, palm oil, corn oil, olive oil, sesame oil, safflower oil, sunflower oil, cottonseed oil, rice-bran oil, peanut oil, palm kernel oil, coconut oil, cacao oil, and other such vegetable oils; cow fat, pig fat, chicken fat, and other such animal fats; medium-chain fatty acid triglycerides; and processed fats and oils obtained by performing fractionation, hydrogenation, ester exchange, etc., on these fats and oils. One type of edible oil or fat may be used alone, or two or more types of edible oils or fats may be used in combination. Among these edible oils or fats, from the standpoint of workability, etc., during production, an edible oil or fat obtained by compounding at least 60% by mass of one or more selected from amonr soybean oil, canola vii, Corn oil, palm olein, and other such oils or fats having an iodine value of 50 or higher is preferred, and an edible oil or fat obtained by compounding at least 80% by mass of the same is more preferred.

When the oxidized oil or fat is used in combination with an edible oil or fat, the oxidized oil or fat content of the overall oil or fat composition preferably is 0.001 to 10% by mass, more preferably is 0.001 to 8% by mass, even more preferably is 0.003 to 8% by mass, and most preferably is 0.005 to 5% by mass. In the oxidized oil or fat content of the overall oil or fat composition, the milk fat included in the oxidized or fat preferably constitutes 0.0001 to 10% by mass, more preferably constitutes 0.0001 to 8% by mass, even more preferably constitutes 0.0003 to 8% by mass, and most preferably constitutes 0.0005 to 5% by mass. Accordingly, the composition of the present invention preferably is prepared by adding the oxidized oil or fat to the edible oil or fat so as to reach the content amounts described above. In addition, an anti-oxidant, an emulsifier, a fragrance, or other such additional ingredients may be furthermore compounded, provided that the additional ingredients do not inhibit the operational effect of the present invention. Specific examples include ascorbic fatty acid esters, lignans, coenzyme Q, y-oryzanol, and tocopherol.

There is no particular limitation as to the form in which the composition for imparting and/or enhancing a cheese flavor according to the present invention is used.; for example, the composition may be used in the form of an oil or fat composition for addition to foods, the oil or fat composition being used by adding to a food after processing or cooking. In addition, the composition may be used in the form of a flavor oil composition, an oil or fat composition for fried foods, an oil or fat composition for stir-fried foods, a dressing, a sauce, etc.

There is no particular limitation as to the mode for addition to foods; the composition may be included as one of the raw ingredients of a food, added to a food after processing or cooking, or configured in the form of a cooking oil and used to cook the food as a cooking oil. However, to more effectively receive the benefit of the operational effect according to the present. invention, the amount of the oxidized oil or fat added to the food preferably is 0.00005 to 3% by mass in terms of the oxidized oil or fat content of the food, more preferably is 0.0001 to 3% by mass, even more preferably is 0.0005 to 2% by mass, and still more preferably is 0.001 to 1% by mass.

The present invention can typically be applied to impart and/or enhance a cheese flavor to/of desired foods; there is no particular limitation as to, inter ante's, the types of foods to which the present invention is applied. Typical examples include gratins, stews, pizza, French fries, pastas, cheese-based processed foods, Doria, cheesecake, and popcorn. The present. invention can be used in a particularly suitable manner in foods that contain cheese, from among the above foods.

As an example of another mode, when the present invention is used as an oil or fat composition for fried foods, preferred examples of such fried foods include French fries, tempura, croquettes, karaage, deep-fried pork cutlet, fried fish, corn dogs, chicken nuggets, deep-ft:Jed tofu, doughnuts, deep-fred bread, fried rice crackers, snack foods, and instant ramen. There is no particular limitation as to the method for producing the fried foods; the fried foods may be produced through methods suited to the fried foods in accordance with the types of the fried foods. Specifically, the prescribed fried-food raw ingredients may be prepared. by frying in a state in. which the composition for imparting and/or enhancing a cheese flavor according to the present invention is used. as an. oil or fat composition. for fried foods, the temperature thereof typically being 150 to 210° C., and more typically being 160 to 200° C.

A discretionary combination of the configurations described in the present specification, a composition or method that includes said configurations, etc., can also be effective as a mode of the present invention. For example, according to the present invention, there are provided “a use for an oxidized oil or fat that has a peroxide value of 15 to 280 and contains 10 to 100% by mass of milk fat, the use being for the purpose of imparting and/or enhancing a cheese flavor”, “a use for an oxidized oil or fat that has a peroxide value of 15 to 280 and contains 10 to 100% by mass of milk fat, the use being for the purpose of producing a composition for imparting and/or enhancing a cheese flavor”, etc.

### EXAMPLES

The present invention is more specifically described below through the use of examples, but the present invention is in no way limited by these examples.

(Preparation of Oxidized Oil or Fat, Part 1)

500 g of anhydrous milk fat (trade name: Butter Oil CML, manufactured by Maruwayushi Co., Ltd. , oil or fat. content: 99.8% by mass, water content: less than 1% by mass) was introduced into a stainless steel beaker, and the milk fat was stirred and air (500 mL/min) was supplied thereto while the milk fat was kept at a temperature of 100° C. A sample was taken after the heat-retention time indicated in table 1, and. an oxidized oil or fat was obtained (preparation examples 1 to 15).

The peroxide value (POV) of the resulting oxidized oil or fat was measured in conformance with the Japan Oil Chemists' Society's “Standard methods for the analysis of fats, oils and related materials: 2.5.2 Peroxide value.” The results are shown in table 1, together with the heat-retention temperature and the heat-retention time used during preparation.

TABLE 1
1-1

| | Preparation | Preparation | Preparation | Preparation | Preparation | Preparation | Preparation | Preparation |
|---|---|---|---|---|---|---|---|---|
| | example 1 | example 2 | example 3 | example 4 | example 5 | example 6 | example 7 | example 8 |
| Heat- | — | 100 | 100 | 100 | 100 | 100 | 100 | 100 |
| retention | | | | | | | | |
| temperature | | | | | | | | |
| (° C.) | | | | | | | | |
| Heat- | 0 | 18 | 19 | 20 | 20.5 | 21 | 22.5 | 23.5 |
| retention | | | | | | | | |
| time | | | | | | | | |
| (hours) | | | | | | | | |
| Peroxide | 0.9 | 15.0 | 30.0 | 45.0 | 60.0 | 80.0 | 110.0 | 140.0 |
| value | | | | | | | | |

1-2

| | Preparation | Preparation | Preparation | Preparation | Preparation | Preparation | Preparation |
|---|---|---|---|---|---|---|---|
| | example 9 | example 10 | example 11 | example 12 | example 13 | example 14 | example 15 |
| Heat- | 100 | 100 | 100 | 100 | 100 | 100 | 100 |
| retention | | | | | | | |
| temperature | | | | | | | |
| (° C.) | | | | | | | |
| Heat- | 24 | 24.5 | 25 | 25.5 | 25.75 | 26 | 26.25 |
| retention | | | | | | | |
| time | | | | | | | |
| (hours) | | | | | | | |
| Peroxide | 160.0 | 180.0 | 200.0 | 220.0 | 240.0 | 250.0 | 265.0 |
| value | | | | | | | |

[Test Example 1] (French Fries, Part 1: Use of High Quantity of Oxidized Oil or Fat)

Canola oil (manufactured by C-Oil Mills, Inc.) was used as an edible oil or fat, 0.1 part by mass of the oxidized oil or fat. in any of preparation examples 1 to 9 was added to 99.9 parts by mass of the edible oil or fat, and an oil or fat composition for addition to foods was obtained (examples 1 to 9). Separately, French fries that are a commercially available frozen food were cooked by frying in canola oil, 8 parts by mass of the oil or fat composition for addition to foods was added to 92 parts by mass of the cooked French fries, and the French fries were thoroughly coated.

Evaluations of the intensity of the butter and cheese flavors of the resulting French fries were collected, the evaluations being carried out by expert panelists (n =3) using the evaluation standard indicated below.

(Evaluation Standard)

⊚: Strongly evident

◯: Evident

Δ: Minimally evident

×: Not evident

The results are shown in table 2.

TABLE 2

| | | | | | Content amount | | |
|---|---|---|---|---|---|---|---|
| | | | Amount added | | in French fries | Intensity | Intensity |
| | Oxidized oil | Peroxide | (percent by | Type of oil | (percent by | of butter | of cheese |
| | or fat | value | mass) | or fat used | mass) | flavor | flavor |
| Control | None added | — | — | Canola oil | — | X | X |
| Example 1 | Preparation | 0.9 | 0.1 | Canola oil | 8.0 | ◯ | X |
| | example 1 | | | | | | |
| Example 2 | Preparation | 15.0 | 0.1 | Canola oil | 8.0 | Δ | Δ |
| | example 2 | | | | | | |
| Example 3 | Preparation | 30.0 | 0.1 | Canola oil | 8.0 | Δ | ◯ |
| | example 3 | | | | | | |
| Example 4 | Preparation | 45.0 | 0.1 | Canola oil | 8.0 | Δ | ⊚ |
| | example 4 | | | | | | |
| Example 5 | Preparation | 60.0 | 0.1 | Canola oil | 8.0 | X | ⊚ |
| | example 5 | | | | | | |
| Example 6 | Preparation | 80.0 | 0.1 | Canola oil | 8.0 | X | ⊚ |
| | example 6 | | | | | | |
| Example 7 | Preparation | 110.0 | 0.1 | Canola oil | 8.0 | X | ⊚ |
| | example 7 | | | | | | |
| Example 8 | Preparation | 140.0 | 0.1 | Canola oil | 8.0 | X | ⊚ |
| | example 8 | | | | | | |
| Example 9 | Preparation | 160.0 | 0.1 | Canola oil | 8.0 | X | ⊚ |
| | example 9 | | | | | | |

According to the results, although. a butter flavor was imparted to the French fries in preparation example 1, in which the peroxide value (POV) of the oxidized oil or fat was 0.9, no cheese flavor was evident. The butter flavor was minimal in preparation example 2, in which the peroxide value (POV) of the oxidized oil or fat was 15.0, in preparation example 3, in which the peroxide value (PUJ) was 30.0, and in preparation example 4, in which the peroxide value (POV) was 45.0, but the cheese flavor became more evident in these preparation examples. No butter flavor was evident in preparation examples 5 to 9, in which the peroxide value (POV) of the oxidized. oil or fat was 60 or higher, but the cheese flavor became strongly evident in these preparation examples. Specifically, as the peroxide value (POV) of the oxidized oil or fat increased, the effect for imparting a butter flavor through. use of the oxidized oil or fat disappeared, but the intensity of a cheese flavor in French fries increased.

[Test Example 2] (French Fries, Part 2: Use of Low Quantity of Oxidized Oil or Fat)

Canola oil was used as an edible oil or fat, 0.1 part by mass of the oxidized oil or fat in any of preparation examples 3 to 9 was added to 99.9 parts by mass of the edible oil or fat, and an oil or fat composition for addjtion to foods was obtained (examples 10 to 16). Separately, French fries that are a commercially available frozen food were cooked by frying in canola oil, 2 parts by mass of the oil or fat composition. for addition to foods was added to 98 parts by mass of the cooked French fries, and the French fries were thoroughly coated.

A flavor evaluation with respect to the intensity of the butter and cheese flavors of the resulting French fries was performed in the same manner as in test example 1.

The results are shown in table 3.

TABLE 3

| | | | | | Content amount | | |
|---|---|---|---|---|---|---|---|
| | | | Amount added | | in French fries | Intensity | Intensity |
| | Oxidized oil | Peroxide | (percent by | Type of oil | (percent by | of butter | of cheese |
| | or fat | value | mass) | or fat used | mass) | flavor | flavor |
| Control | None added | — | — | Canola oil | — | X | X |
| Example 10 | Preparation | 30.0 | 0.1 | Canola oil | 2.0 | Δ | Δ |
| | example 3 | | | | | | |
| Example 11 | Preparation | 45.0 | 0.1 | Canola oil | 2.0 | Δ | ◯ |
| | example 4 | | | | | | |
| Example 12 | Preparation | 60.0 | 0.1 | Canola oil | 2.0 | X | ⊚ |
| | example 5 | | | | | | |
| Example 13 | Preparation | 80.0 | 0.1 | Canola oil | 2.0 | X | ⊚ |
| | example 6 | | | | | | |
| Example 14 | Preparation | 110.0 | 0.1 | Canola oil | 2.0 | X | ⊚ |
| | example 7 | | | | | | |
| Example 15 | Preparation | 140.0 | 0.1 | Canola oil | 2.0 | X | ⊚ |
| | example 8 | | | | | | |
| Example 16 | Preparation | 160.0 | 0.1 | Canola oil | 2.0 | X | ⊚ |
| | example 9 | | | | | | |

According to the results, the same trend was observed as in the results of test example 1. Specifically, in preparation example 3, in which the peroxide value (POV) of the oxidized oil or fat was 30.0, and in preparation example 4, in which the peroxide value (POV) was 45.0, a cheese flavor was imparted to the French fries in addition to a minimal butter flavor. In preparation examples 5 to 9, in which the peroxide value (POV) of the oxidized oil or fat was 60 or higher, no effect for imparting a butter flavor was observed, but a cheese flavor was more strongly evident in. the French fries as the peroxide value (POV) of the oxidized oil or fat increased.

[Test Example 3] (French Fries, Part 3: Use of High-POV Oxidized Oil or Fat)

Canola oil was used as an edible oil or fat, 0.1 part by mass of the oxidized oil or fat in any of preparation examples 9 to 15 was added to 99.9 parts by mass of the edible oil or fat, and an oil or fat composition for addition to foods was obtained (examples 17 to 23). Separately, French fries that are a commercially available frozen food were cooked by frying in canola oil, 2 parts by mass of the oil or fat composition for addition to foods was added to 98 parts by mass of the cooked French fries, and the French fries were thoroughly coated.

A flavor evaluation with respect to the intensity of the butter and cheese flavors of the resulting French fries was performed in the same manner as in test example 1.

The results are shown in table 4.

TABLE 4

| | | | | | Content amount | | |
|---|---|---|---|---|---|---|---|
| | | | Amount added | | in French fries | Intensity | Intensity |
| | Oxidized oil | Peroxide | (percent by | Type of oil | (percent by | of butter | of cheese |
| | or fat | value | mass) | or fat used | mass) | flavor | flavor |
| Control | None added | — | — | Canola oil | — | X | X |
| Example 17 | Preparation | 160.0 | 0.1 | Canola oil | 2.0 | X | ⊚ |
| | example 9 | | | | | | |
| Example 18 | Preparation | 180.0 | 0.1 | Canola oil | 2.0 | X | ⊚ |
| | example 10 | | | | | | |
| Example 19 | Preparation | 200.0 | 0.1 | Canola oil | 2.0 | X | ⊚ |
| | example 11 | | | | | | |
| Example 20 | Preparation | 220.0 | 0.1 | Canola oil | 2.0 | X | ⊚ |
| | example 12 | | | | | | |
| Example 21 | Preparation | 240.0 | 0.1 | Canola oil | 2.0 | X | ⊚ |
| | example 13 | | | | | | |
| Example 22 | Preparation | 250.0 | 0.1 | Canola oil | 2.0 | X | ⊚ |
| | example 14 | | | | | | |
| Example 23 | Preparation | 265.0 | 0.1 | Canola oil | 2.0 | X | ⊚ |
| | example 15 | | | | | | |

According to the results, the same trend was observed as in the results of test examples 1 and 2. Specifically, in preparation examples 9 to 15, in which the peroxide value (POV) of the oxidized oil or fat was 160.0 or higher, no effect for imparting a butter flavor was observed, but a cheese flavor was strongly evident, in the French fries.

(Preparation of Oxidized Oil or Fat, Part 2)

The following were prepared: (1) an oil or fat including 20% by mass of milk fat, the oil or fat being obtained by mixing 80 parts by mass of high-oleic-acid low-linoleic-acid canola oil (HOLL canola oil) (manufactured by J-Oil Mills, Inc., water content: less than 1% by mass) into 20 parts by mass of anhydrous milk fat; (2) an oil or fat including 50% by mass of milk fat, the oil or fat being obtained by mixing 50 parts by mass of the ROLL canola oil into 50 parts by mass of the anhydrous milk fat; and (3) anhydrous milk fat. 200 g of the prepared oil or fat or anhydrous milk fat was introduced into a stainless steel beaker, and the oil or fat was stirred and air (200 mL/min) was supplied thereinto while the oil or fat was kept at a temperature of 100° C. A sample was taken after each of 30, 36, and 22 hours, respectively, and an oxidized oil or fat was obtained (preparation examples 16 to 18).

The peroxide value (POV) of the resulting oxidized. oil or fat was measured in conformance with the Japan Oil Chemists' Society's “Standard methods for the analysis of fats, oils and related materials: 2.5.2 Peroxide value.” The results are shown in table 5, together with the compounding amounts of the anhydrous milk fat and the HOLT, canola oil, the heat-retentjon temperature, and the heat-retention time.

TABLE 5

| | Preparation | Preparation | Preparation |
|---|---|---|---|
| | example 16 | example 17 | example 18 |
| Anhydrous milk | 20 | 50 | 100 |
| fat (parts by | | | |
| mass) | | | |
| HOLL canola oil* | 80 | 50 | 0 |
| (parts by mass) | | | |
| Heat-retention | 100 | 100 | 100 |
| temperature (° C.) | | | |
| Heat-retention | 30 | 36 | 22 |
| time (hours) | | | |
| Peroxide value | 105.0 | 100.0 | 100.0 |

HOLL canola oil*: High-oleic-acid low-linoleic-acid canola oil

[Test Example 4] (French Fries, Part 4: Use of Oxidized Oil or Fat Prepared Using Raw-Ingredient Oil or Fat in Which Milk Fat and Edible Oil or Fat Other Than Milk Fat are Mixed)

Canola oil was used as an edible oil or fat, 0.1 part by mass of the oxidized oil or fat in any of preparation examples 16 to 18 was added. to 99.9 parts by mass of the edible oil or fat, and an oil or fat composition for addition to foods was obtained (examples 24 to 26). Separately, French fries that are a commercially available frozen food. were cooked by frying in canola oil, 2 parts by mass of the oil or fat composition for addition to foods was added to 98 parts by mass of the cooked French fries, and the French fries were thoroughly coated.

A flavor evaluation with respect to the intensity of the cheese flavor of the resulting French fries was performed in the same manner as in test example 1.

The results are shown in table 6.

TABLE 6

| | | | | | Content amount | |
|---|---|---|---|---|---|---|
| | | | Amount added | | in French fries | Intensity |
| | Oxidized | Peroxide | (percent by | Type of oil | (percent by | of cheese |
| | oil or fat | value | mass) | or fat used | mass) | flavor |
| Control | None added | — | — | Canola oil | — | X |
| Example 24 | Preparation | 105.0 | 0.1 | Canola oil | 2.0 | ◯ |
| | example 16 | | | | | |
| Example 25 | Preparation | 100.0 | 0.1 | Canola oil | 2.0 | ⊚ |
| | example 17 | | | | | |
| Example 26 | Preparation | 100.0 | 0.1 | Canola oil | 2.0 | ⊚ |
| | example 18 | | | | | |

According to the results, even in. cases where there was used an oxidized. oil or fat prepared using a raw-ingredient oil or fat obtained by mixing milk fat and an edible oil or fat other than milk fat, the same trend was observed as in the results of test examples 1 to 3. Specifically, a cheese flavor was imparted to French. fries by adding the oxidized oil or fat in preparation example 16, which had a peroxide value (POV) of 105.0 and was obtained from a raw-ingredient oil or fat including 20% by mass of milk fat. In addition, a cheese flavor was strongly evident in the case of adding the oxidized oil or fat in preparation example 17, which had a peroxide value (POV) of 100.0 and was obtained. from a raw-ingredient oil or fat including 50% by mass of milk fat, and the same is true for the addition. of the oxidized oil or fat in preparation example 18, which had a peroxide value (PEW) of 100.0 and was obtained from a raw-ingredient oil or fat consisting of anhydrous milk fat.

[Test Example 5] (Gratin)

Canola oil was used as an edible oil or fat, 1 part by mass of the oxidized oil or fat in preparation example 7 (POV: 110.0) was added to 99 parts by mass of the edible oil or fat, and an oil or fat composition for addition. to foods was obtained (example 27). A gratin that is a commercially available frozen food and includes cheese as a raw ingredient was heated with a microwave oven, 1 part by mass of the oil or fat composition for addition to foods in example 27 was added to 99 parts by mass of the gratin, and the ingredients were thoroughly mixed.

The resulting gratin had an increased cheese-like acidity and an enhanced cheese flavor to a greater extent than in a case where no oil or fat composition for addition to foods was added.

[Test Example 6] (Natural Cheese)

Commercially available natural cheese (trade name: Torokeru Mix Cheese, manufactured by Eight Cooperative Buying Co., Ltd.) was heated and melted with a microwave oven, 1 part by mass of the oil or fat. composition for addition to foods in example 27 was added. to 99 parts by mass of the natural cheese, and the ingredients were thoroughly mixed.

The resulting natural cheese had a deeper aftertaste, increased richness, and an enhanced cheese flavor to a greater extent than in a case where no oil or fat composition for addition to foods was added.

[Test Example7] (Stew)

The oil or fat composition for addition to foods in example 27 was added to a stew prepared using a commercially available roux (including cheese) in such an amount as to reach a final concentration of 0.5, 1, 2, or 5% by mass, and the ingredients were thoroughly mixed.

An evaluation of the intensity of the cheese flavor of the resulting stew was collected, the evaluation being carried out by expert panelists (n=3) using the evaluation standard indicated below.

(Evaluation standard)

⊚: Much stronger than when none is added

◯: Stronger than when none is added

Δ: Somewhat stronger than when none is added

×: Same as when none is added

The results are shown in table 7.

TABLE 7

| Amount added | Intensity of cheese flavor |
|---|---|
| None added | X |
| 0.5% by mass | ◯ |
| 1% by mass | ◯ |
| 2% by mass | ◯ |
| 5% by mass | ⊚ |

According to the results, the resulting stew had. increased cheesiness and an enhanced cheese flavor to a greater extent than in a case where no oil or fat composition for addition to foods was added.

(Preparation of Oxidized Oil or Fat, Part 3)

Two types of oils or fats were prepared, the oils or fats including 70% by mass of milk fat in which 60 g of a medium-chain fatty acid. triglyceride (trade name: MCI Actor M-107FR, manufactured by Riken Vitamin Co. , Ltd. , water content: less than 1% by mass) or soybean oil (manufactured by J-Oil Mills, Inc., water content: less than 1% by mass) , respectively, was mixed into 140 g of anhydrous milk fat. 200 g of the prepared oils or fats was introduced into respective stainless steel beakers, and the oils or fats were stirred and air (200 mL/min) was supplied while the oils or fats were kept at a temperature of 120° C. A reaction was carried out for 13 hours, and. oxidized oils or fats were obtained. (preparation examples 19 and 20).

The peroxide value (POV) of the resulting oxidized oils or fats was measured in conformance with the Japan Oil Chemists' Society's “Standard methods for the analysis of fats, oils and related. materials: 2.5.2 Peroxide value.” According to the results, the peroxide value (POV) in preparation example 19 was 58.7, and the peroxide value (POV) in preparation example 20 was 44.6.

<Production Example 1>(Production of Oil or Fat Composition for Addition to Foods in Which There is Added Oxidized Oil or Fat Prepared Using Raw-ingredient Oil or Fat in Which Milk Fat and Edible Oil or Fat Other Than Milk Fat are Mixed)

1 part by Mass of the oxidized oil or fat in either preparation example 19 or preparation example 20 was added to 99 parts by mass of soybean oil, and an oil or fat composition for addition to foods was obtained (examples 28 and 29).

[Test Example 8] (Example of Use as Oil or Fat Composition for Fried Foods)

Palm oiein (iodine value: 67) (manufactured by J-Oil Mills, Inc.) was used. as an. edible oil or fat, 0.3 parts by mass of the oxidized. oil or fat in preparation example 7 was added to 99.7 parts by mass of the edible oil or fat, and an oil or fat composition for addition to foods was obtained. (example 30). Commercially available frozen French fries (trade name: Shoestring French Fries, manufactured by Ajinomoto Frozen Food. Co., Ltd.) were cooked by frying at 180° C. using the oil or fat composition for addition to foods in example 30. Once the French fries were consumed after being cooked, it was found that a cheese flavor was strongly evident therein.

1. A composition for imparting and/or enhancing a cheese flavor, the composition comprising, as an active ingredient, an oxidized oil or fat that has a peroxide value of 15 to 280 and contains 10 to 100% by mass of milk fat.

2. The composition for imparting and/or enhancing a cheese flavor according to claim 1, wherein the composition further comprises an edible oil or fat.

3. The composition for imparting and/or enhancing a cheese flavor according to claim 1, wherein the composition contains 0.001 to 10% by mass of the oxidized oil or fat.

4. A method for producing a composition for imparting and/or enhancing a cheese flavor,
the method comprising a step for performing heating while supplying oxygen to a raw-ingredient oil or fat that contains 10 to 100% by mass of milk fat, and obtaining an oxidized oil or fat that has a peroxide value of 15 to 280.

5. The method for producing a composition for imparting and/or enhancing a cheese flavor according to claim 4, wherein the raw-ingredient oil or fat contains 60 to 100% by mass of milk fat.

6. The method for producing a composition for imparting and/or enhancing a cheese flavor according to claim 4, wherein the heating is carried out at 65 to 150° C. for 1 to 72 hours.

7. The production method according to claim 4, wherein the supply of oxygen is performed at a rate of 0.001 to 2 L/min per kilogram of the raw-ingredient oil or fat.

8. The method for producing a composition for imparting and/or enhancing a cheese flavor according to claim 4, wherein the milk fat is anhydrous milk fat.

9. The method for producing a composition for imparting and/or enhancing a cheese flavor according to claim 4, wherein the method comprises a step for adding the oxidized oil or fat to an edible oil or fat.

10. The method for producing a composition for imparting and/or enhancing a cheese flavor according to claim 9, wherein the method is configured such that the composition contains 0.001 to 10% by mass of the oxidized oil or fat.

11. The method for producing a composition for imparting and/or enhancing a cheese flavor according to claim 4, wherein the food contains a cheese.

12. A method for imparting a cheese flavor to foods or enhancing the cheese flavor of foods, the method being characterized in that an oxidized oil or fat having a peroxide value of 15 to 280 and containing 10 to 100% by mass of milk fat is added to a food.

13. The method for imparting a cheese flavor to foods or enhancing the cheese flavor of foods according to claim 12, wherein the oxidized oil or fat is added to the food as a composition further containing an edible oil or fat.

14. The method for imparting a cheese flavor to foods or enhancing the cheese flavor of foods according to claim 12, wherein the food contains a cheese.

15. The method for imparting a cheese flavor to foods or enhancing the cheese flavor of foods according to claim 12, wherein the amount of the oxidized oil or fat added to the food is 0.00005 to 3% by mass in terms of the oxidized oil or fat content of the food.

16. A method for producing foods with an imparted/enhanced cheese flavor, the method comprising adding the composition for imparting and/or enhancing a cheese flavor according to claim 1 to a food.

17. The method for producing foods with an imparted/enhanced cheese flavor according to claim 16, wherein the food contains a cheese.
